(19) United States
(12) Patent Application Publication
(10) Pub. No.: US 2021/0368320 A1
(43) Pub. Date: Nov. 25, 2021

(54) EMPLOYING DATA FROM A COMBINATION OF CELL SECTORS

(71) Applicant: NG911 Services, Inc, Bellevue, WA (US)

(72) Inventor: Donald Le Roy Mitchell, JR., Bellevue, WA (US)

(21) Appl. No.: 17/328,064

(22) Filed: May 24, 2021

Related U.S. Application Data
(60) Provisional application No. 63/029,623, filed on May 25, 2020.
(60) Provisional application No. 63/038,796, filed on Jun. 13, 2020.

(51) Int. Cl. H04W 4/90; H04W 76/50; H04W 4/021

(52) U.S. Cl. CPC H04W 4/90; H04W 4/022; H04W 76/50

(57) ABSTRACT

A geospatial shape generator receives cell sector data for cell sectors, wherein the cell sector data characterizes geocoordinates of cell towers for the cell sectors and a radius of communication of each cell sector. The geospatial shape generator can generate a geospatial shape for the cell sectors. The geospatial shape server can also include a boundary coordinator that queries a Geographic Information System (GIS) for geographic coordinates for a particular region of interest within boundaries of each respective geospatial shape. The boundary coordinator can also determine a unique boundary for the particular region of interest, wherein the unique boundary is a combination of the geospatial shapes that encompass the particular region of interest. The geospatial shape server can include a call route control that routes emergency service calls that originate within the unique boundary to a particular network node of a public safety network.

### CROSS-REFERENCE TO RELATED APPLICATIONS

This application claims the benefit of priority to U.S. Provisional Application No. 63/029,623, filed on 25 May 2020 and to U.S. Provisional Application No. 63/038,796, filed on 13 Jun. 2020, the entirety of each is herein incorporated by reference.

### TECHNICAL FIELD

This disclosure relates to emergency services calls, and more particularly, to routing emergency services calls.

### BACKGROUND

“9-1-1” (or “911”) is an emergency telephone number for the North American Numbering Plan (NANP), one of eight N11 codes. In North American jurisdictions, special privacy legislation permits emergency operators to obtain a 9-1-1 caller's telephone number and location information. For wireline telephones, this information is gathered by mapping the calling phone number to an address in a database. This database function is known as location data source. The database is generally maintained by the local telephone company, under a contract with a Public Service Answering Point (PSAP).

A PSAP is a call center responsible for answering calls to an emergency telephone number for police, firefighting and ambulance services. Trained telephone operators may also be responsible for dispatching these emergency services. Most PSAPs are capable of caller location for landline calls, and many can handle mobile phone locations as well (sometimes referred to as phase II location), where the mobile phone company has a handset location system.

### SUMMARY

One example relates to a geospatial shape generator that receives cell sector data for cell sectors, wherein the cell sector data characterizes a radius of communication of each cell sector and geocoordinates of cell towers for the cell sectors. The cell sectors can include a first set of cell sectors that communicate on a first carrier network and a second set of cell sectors that communicate on a second carrier network, different than the first carrier network. The geospatial shape generator can generate a geospatial shape for the sell sectors, wherein the geospatial shape for each respective cell sector characterizes geographical boundaries of a corresponding cell sector. The geospatial shape server can further include a boundary coordinator that receives a request from a policy management engine that indicates a particular region of interest. The boundary coordinator can query a Geographic Information System (GIS) for geographic coordinates for the particular region of interest within boundaries of each respective geospatial shape. Accordingly, the boundary coordinator can generate a unique boundary that is a combination of geospatial shapes that encompass the particular region of interest identified by the GIS. Moreover, the geospatial shape server can further include a call route control that receives a request to associate the unique boundary with the particular region of interest. In response, the call route control can provide a GIS reference characterizing the unique boundary to a network node of a public safety network that determines destination routing for emergency calls within the particular region of interest.

Another example relates to a non-transitory machine readable medium storing machine executable instructions. The machine executable instructions can include a geospatial shape generator that receives cell sector data for cell sectors, wherein the cell sector data characterizes a radius of communication of each cell sector, a beam width for each cell sector, and geocoordinates of cell towers for the cell sectors. The cell sector data can further indicate a first set of the cell sectors that communicate on a first carrier network and a second set of the cell sectors communicate on a second carrier network, different from the first carrier network. The geospatial shape generator can generate a geospatial shape for the cell sectors, wherein the geospatial shape for each respective cell sector characterizes geographical boundaries of a corresponding cell sector. The machine executable instructions can further include a boundary coordinator that receives a request from a policy management engine that indicates a particular region of interest. The boundary coordinator can query a geographic information system (GIS) for geographic coordinates for the particular region of interest within boundaries of each respective geospatial shape and generate a unique boundary that is a combination of geospatial shapes that encompass the particular region of interest identified by the GIS. The machine executable instructions can further include a call route control that receives a request to associate the unique boundary with the particular region of interest. In response, the call route control can provide a GIS reference characterizing the unique boundary to a network node of a public safety network that determines destination routing for emergency calls within the unique boundary.

Still another example relates to a method that includes receiving cell sector data for cell sectors. The cell sector data characterizes a radius of communication of each cell sector, a beam width of each cell sector, and geocoordinates of cell towers for the cell sectors, wherein a first set of the cell sectors communicate on first carrier network and a second set of the cell sectors communicate on a second carrier network, different from the first carrier network. The method can also include generating a geospatial shape for the cell sectors, wherein the geospatial shape for each respective cell sector characterizes geographical boundaries of coverage for a particular protocol on a particular communication network. The method can further include receiving a request indicating a particular region of interest and querying a geographic information system (GIS) for geographic coordinates for a particular region of interest within boundaries of each respective geospatial shape. The method can also include determining a unique boundary that is a combination of geospatial shapes that encompass the particular region of interest identified by the GIS. Moreover, the method can include receiving a request to associate the unique boundary with the particular region of interest and indicating a particular Public Answering Safety Point (PSAP). In response, the method can include providing a GIS reference characterizing the unique boundary and PSAP to a network node of a public safety network that determines destination routing for emergency calls.

### BRIEF DESCRIPTION OF THE DRAWINGS

FIG. 1 illustrates an example of a system configured to route emergency services calls.

FIG. 2 illustrates an example of a plurality of geospatial shapes.

FIG. 3 illustrates an example of a graphical user interface display including a plurality of geospatial shapes.

FIG. 4 illustrates an example of unique boundary that is a union of a plurality of geospatial shapes.

FIG. 5 illustrates another example of a plurality of geospatial shapes.

FIG. 6 illustrates another example of a plurality of geospatial shapes.

FIG. 7 illustrates another example of a graphical user interface display including a plurality of geospatial shapes.

FIG. 8 illustrates another example of unique boundaries.

FIG. 9 illustrates another example of a plurality of geospatial shapes.

FIG. 10 illustrates a timing diagram of a system for routing an emergency services call.

FIG. 11 illustrates a flowchart of an example method for routing an emergency services call.

### DETAILED DESCRIPTION

Systems and methods are disclosed for routing emergency services calls. More particularly, the systems and methods described herein employ a geospatial shape server to assist with routing emergency services calls for a multiparty emergency incident (e.g., an emergency involving more than one party). The geospatial shape server can receive cell sector data characterizing geocoordinates for each of a plurality of cell sectors. The cell sector data of each cell sector identifies a location of a corresponding cell tower. The cell tower can include an antenna (or multiple antennas) for a telecommunication system. Moreover, different cell towers may be provided by different telecommunication systems (e.g., different telecommunications providers). The cell sector data can be provided from an agency. In some examples, the cell sector data can be a text file, such as a comma separated value (CSV) file, a spread sheet, a JavaScript Object Notation (JSON) file, or other document. The cell sector data characterizes geocoordinates (e.g., latitude and longitude) of each corresponding cell tower, a radius of communication of each cell sector and a beam width of each cell sector. Additionally, the cell sector data characterizes a carrier network associated with each corresponding cell tower (e.g., VERIZON®, T-MOBILE®, SPRINT®, AT&T®), as well as particular communication protocol of the cell sector (e.g., 3G, 4G, 4G Long Term Evolution (LTE), 5G etc.). The geospatial shape server can generate a geospatial shape for each of the plurality of cell sectors. The geospatial shape for each respective cell sector characterizes geographical boundaries of a corresponding cell sector partition, such as a cell sector wedge or other shape. Because the cell sectors may be provided from different telecommunication systems, some of the geospatial shapes can overlap.

The geospatial shape server can query a Geographical Information System (GIS) for geographic coordinates for a particular region of interest within boundaries of each respective geospatial shape. A particular region of interest can be identified by a user via a menu (e.g., dropdown menu) in a Graphical User Interface (GUI). The GUI can include a view of geospatial shapes for the cell sectors generated by the geospatial shape generator and further provide a menu that allows entry of user input to populate the set of data that defines the particular region of interest. Accordingly, a particular region of interest can be, for example, a segment of a highway, a district or ward of a city, a park, a hospital system, an educational facility (e.g., a primary education or University campus), etc. The geospatial shape server can determine a unique boundary identified by the GIS. The unique boundary can be, for example, a combination of a plurality of geospatial shapes joined in a union, or an intersectional area bounded by each of the plurality of geospatial shapes. The unique boundary can be stored in a database (e.g., a relational database). These operations can be preprocessed in order for the geospatial server to generate a unique boundary associated with a particular region of interest.

The geospatial server can provide a client portal, (e.g., a call control module) such as a web interface or a portal for a dedicated client. A client (e.g., a web browser or a dedicated client) can access the client portal to provide a GUI. The GUI can display a map and a plurality of geospatial shapes generated by the geospatial server. Additionally, the GUI can receive input from the user indicating a particular region of interest on the map. Particularly, the GUI can display a form configured to receive user input, such as geographical coordinates. Additionally or alternatively, the GUI can display a drop down menu configured to receive user input indicating particular locations on the map, such as mile markers on a highway. Accordingly, user input received by the GUI can be employed by the geospatial server to determine a particular region of interest. Moreover, the particular region of interest can be employed by the geospatial shape server to generate a unique boundary. In this manner, the client can be employed to request that the geospatial server route calls from devices within the unique boundary associated with the particular region of interest to a given emergency call handling system.

The given emergency call handling system can be, for example, a particular PSAP of a plurality of PSAPs or a specific PSAP answering group within a particular PSAP. In response to the request, the geospatial shape server can provide a GIS reference for use by network elements that determine destination routing for calls within the unique boundary to the given emergency handling system. The GIS reference can be provided, for example, to an emergency call routing function (ECRF) of a public safety network to route emergency calls within the unique boundary to the given emergency handling system. In other examples, the GIS reference can be provided to another or additional nodes (e.g., a LoST server) of the public safety network that can determine a network routing identifier based on the GIS reference. The GIS reference can include data characterizing the unique boundary (e.g., latitude and longitude coordinates) associated with the particular region of interest. In response to the GIS reference, the ECRF can provide a uniform resource locator (URI) for the given emergency call handling system for some (or all) emergency calls within the emergency region of the unique boundary. In some examples, the GIS reference can include the URI of the given emergency call handling system. In other examples, the ECRF can determine the URI for the given emergency call handling system.

By employing the systems and methods described herein, an emergency incident (e.g., a multivehicle accident, a school shooting, a terrorist attack, etc.) can be determined be a particular region of interest (e.g., a highway, a campus, etc.), such that the geospatial server can generate a unique boundary for the particular region of interest. Accordingly, calls likely associated with the emergency incident within the unique boundary can be routed to a specific PSAP or a specific answering group within a specific PSAP (e.g., a highway patrol, campus police, etc.). This routing reduces the chances that such calls would be routed to the wrong PSAP, thereby curtailing the number of call transfers needed.

For example, an emergency incident can occur in a region that is overlapped by a plurality of geospatial shapes that each represent a different cell sector. Each of the cell sectors represented by the geospatial shapes can correspond to a given PSAP of a plurality of PSAPs. Conventionally, a plurality of emergency services calls reporting the emergency incident that originate within the region are routed through any, or each of, the cell towers serving the region that are represented by overlapping geospatial shapes. Accordingly, a given emergency services call of the plurality of emergency services calls reporting the emergency incident can be routed to various different PSAPs of the plurality of PSAPs based on the cell sector that handles the call. However, a particular (single) PSAP is likely the most appropriate PSAP based on the location of the emergency incident and/or the nature of the emergency incident. Consequently, calls that are forwarded to a PSAP other than the particular PSAP need to be transferred to the particular PSAP. By creating a unique boundary around a particular region of interest, each of the calls originating within the unique boundary can be routed to the particular PSAP, independent of the cell sector that routes the call. In this manner, a large volume of emergency services calls related to an emergency incident within the particular region can be efficiently handled to expedite the dispatch of emergency services and concurrently curtailing the number of transfers needed to handed these emergency services calls.

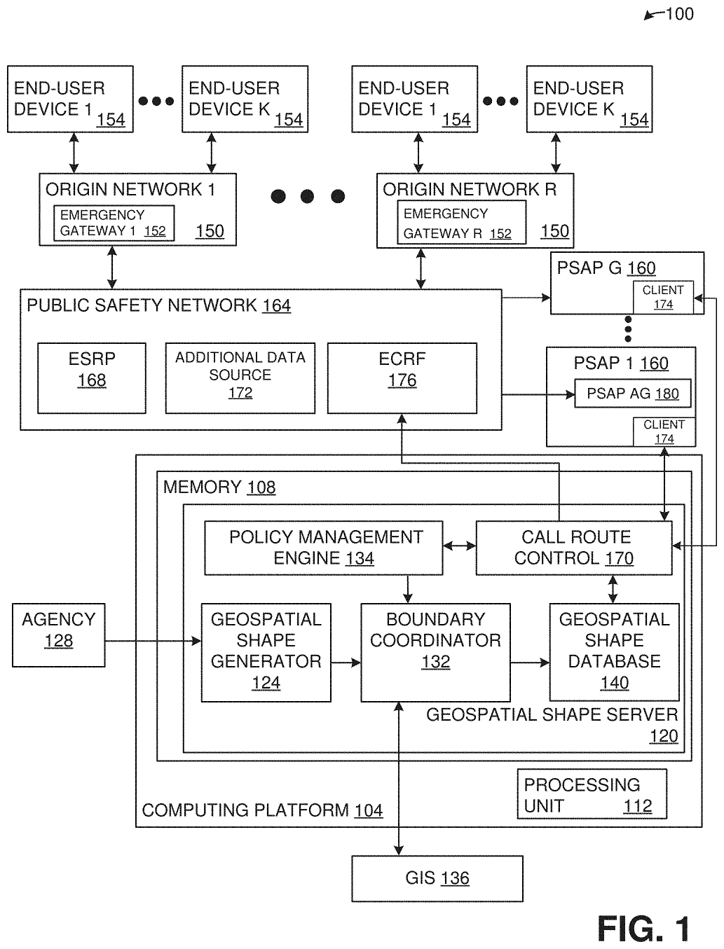

FIG. 1 illustrates an example of a system 100 configured to facilitate the processing of emergency services calls. Communication between nodes of the system 100 can be conducted via a private network (e.g., a wireless carrier network), a public network (e.g., the Internet), or a combination thereof.

The system 100 can include a computing platform 104. Accordingly, the computing platform 104 can include a memory 108 for storing machined readable instructions and data and a processing unit 112 for accessing the memory 108 and executing the machine-readable instructions. The memory 108 represents a non-transitory machine-readable memory (or other medium), such as random access memory (RAM), a solid state drive, a hard disk drive or a combination thereof. The processing unit 112 can be implemented as one or more processor cores. The computing platform 104 can include a network interface (not shown), such as a network interface card configured to communicate with other nodes of the system 100.

The computing platform 104 could be implemented in a computing cloud. In such a situation, features of the computing platform 104, such as the processing unit 112, the network interface, and the memory 108 could be representative of a single instance of hardware or multiple instances of hardware with applications executing across the multiple of instances (i.e., distributed) of hardware (e.g., computers, routers, memory, processors, or a combination thereof). Alternatively, the computing platform 104 could be implemented on a single dedicated server or workstation. Furthermore, in some examples the computing platform 104 can be employed to implement other nodes of the system 100 in a similar manner. However, for purposes of simplification of explanation, only the details of the computing platform 104 are illustrated.

The memory 108 can include a geospatial shape server 120. The geospatial shape server 120 can be configured/programmed to determine geospatial shapes for cell sectors and assist in the routing of emergency calls based on the determined geospatial shapes. The geospatial shape server 120 can include modules that execute specific operations to assist with these tasks. More particularly, the geospatial shape server can include a geospatial shape generator 124. The geospatial shape generator 124 can generate geospatial shapes that characterize geographic boundaries of a coverage area of cell sectors (e.g., a cellular base station or cell site antenna). As noted, each cell sector includes a cell tower that represents a cellular network point of ingress and egress.

In some examples, the geospatial shape generator 124 can receive cell sector data for a plurality of cell sectors from an agency 128, such as a safety agency. The agency 128 can be representative of a network node. In other examples, a different entity (or multiple entities) can provide the cell sector data. The cell sector data can be, for example raw data or formatted data representing characteristics of a radiation pattern for cell towers in each of a plurality of cell sectors in a geographic region (e.g., a political boundary). For example, the raw data can include geographic coordinates (e.g., latitude and longitude coordinates), a radius, and a beam width for each cell sector. As one example, the cell sector data can be provided, for example as a spreadsheet, such as a comma separate value (CSV) file, a spread sheet, a JSON file, or other document.

Each cell sector can be associated with a particular telecommunications carrier. Each cell sector can be, for example a second generation (2G) cell sector, a third generation (3G) cell sector, a Long Term Evolution (LTE) cell sector, a fifth generation (5G) cell sector, etc. Moreover, the cell sector data can include data for cell towers of different telecommunications carriers. In such a situation, the area covered by different cell sectors can overlap.

The geospatial shape generator 124 can employ the cell sector data to calculate a geospatial shape for each cell sector of the plurality of cell sectors. Each such geospatial shape can be represented by geographic boundaries defined in latitude and longitude coordinates. Each such geospatial shape can represent, for example an antenna coverage area, a cell site sector partition, such as a cell sector wedge, or a shape similar to a cell site sector wedge. The region within each geospatial shape can be associated with a particular Public Safety Answering Point (PSAP). Accordingly, emergency calls originating from the region within each geospatial shape are routed to a respective PSAP.

The examples provided relate to cellular telecommunication networks. However, this is just one example. The system 100 is adaptable for any RF communication protocol, such as Wi-Fi, Bluetooth, etc. In any such situation, the geospatial shape server 120 can be provided information from the agency 128 characterizing a location of a wireless access point (WAP) or multiple WAPs. The WAP can be, for example, a Wi-Fi router, or a Bluetooth access point. In this situation, the geospatial shape generator 124 can be configured/programmed to generate geographic boundaries for a shape (e.g., a wedge, a circle, etc.) that represents an antenna coverage area defined in latitude and longitude coordinates for each such WAP. The coverage areas for each WAP have properties similar to a cell sector, such as beam width, radius, etc. Accordingly, for purposes of simplification of explanation, such coverage areas (and/or a partition of a coverage area) for each of a plurality of WAPs can also colloquially be referred to as a cell sector (and/or a cell sector partition, such as a cell sector wedge).

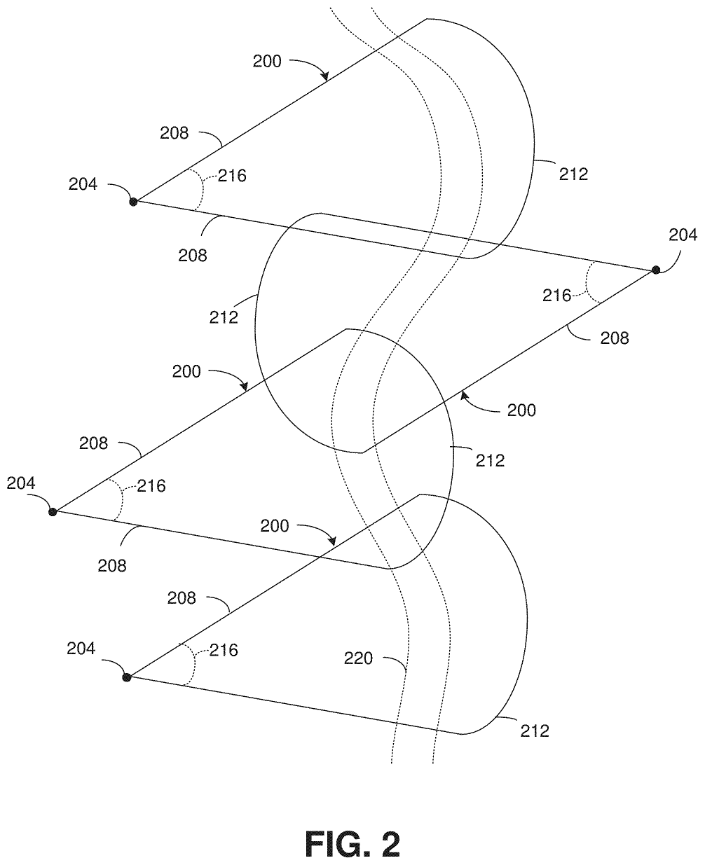

FIG. 2 illustrates a diagram a plurality of a geospatial shapes 200 for a corresponding cell sector of one or more cell sectors. Each geospatial shape 200 includes a point 204 that represents a location of a cell tower of the corresponding cell sector. In the example illustrated, each geospatial shape 200 is a wedge or cone shape, but in other examples, other shapes are possible. Moreover, in the example illustrated, each geospatial shape 200 represents a two-dimensional (2D) shape, but in other examples, the geospatial shape can be implemented as a three-dimensional (3D) shape. Each edge 208 has a length about equal to the radius defined in the cell sector data. Moreover, a base 212 of each geospatial shape 200 is based on the beam width 216 of the corresponding cell sector (defined in degrees or radians) and the cell tower positioned at the point 204. The boundaries of each geospatial shape 200 can be defined in latitude and longitude coordinates. Additionally, FIG. 2 illustrates a highway 220 travelling through the illustrated geospatial shapes 200.

Moreover, each of the geospatial shapes 200 of cell sector partitions (cell sector wedges) can correspond to different telecommunications providers. Furthermore, the geospatial shapes 200 can be associated with a various PSAPs. In one example, a first set of the geospatial shapes 200 may be associated with a first PSAP, and a second set of the geospatial shapes 200 may be associated with a second PSAP. In other examples, each of the geospatial shapes 200 is be associated with a different PSAP. In normal conditions, emergency calls originating within each geospatial shape 200 are forwarded to the corresponding PSAP. However, in certain circumstances, such as a multiparty emergency incident, some (or all) emergency services calls originating within any of the geospatial shapes 200 should be routed to an emergency handling system such as a particular PSAP, and more specifically, to an answer group within the particular PSAP.

Referring back to FIG. 1, the geospatial shape generator 124 can provide each calculated geospatial shape to a boundary coordinator 132 of the geospatial shape server 120 in response to receiving a request from a policy management engine 134 of the geospatial shape server. The request provided by the policy management engine 134 indicates a particular region of interest, which can be an area defined by geographical coordinates. Additionally, or alternatively, the particular region of interest can be defined by geographical indicators such as mile markers on a highway, highways, streets, or naturally occurring geography (e.g., rivers, valleys, mountains). Moreover, the policy management engine can provide a user with a Graphical User Interface (GUI) to describe or select a particular region of interest.

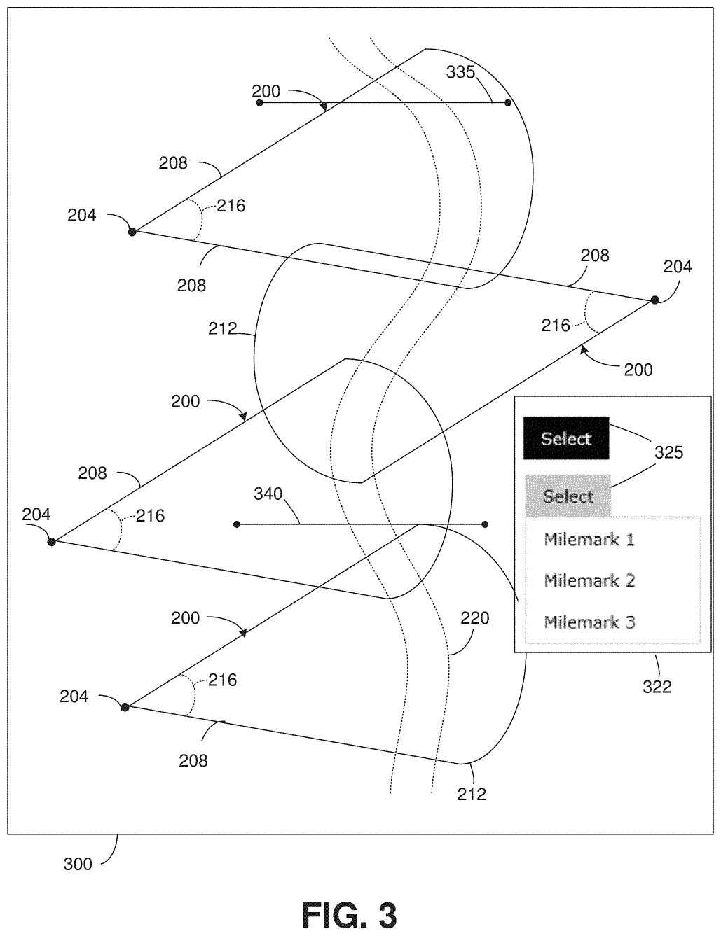

FIG. 3 illustrates an example of a GUI 300 provided by the policy management engine 134 of FIG. 1. For purposes of simplification, the GUI 300 of FIG. 3 displays the plurality of geospatial shapes 200 and highway 220 of FIG. 2. The GUI 300 can display a map or view of a geographical area and can provide controls to zoom in and out, as well as pan around the map. As illustrated, the GUI 300 provides user controls to enable a user to pan to and/or zoom-in on, the highway 220. Alternatively, the GUI 300 enables user input to populate a data field characterizing geographical coordinates to locate the highway 220. Additionally, the GUI 300 can provide a dropdown menu 322 that allows inputting of information to indicate a particular region of interest associated with the highway 220. The dropdown menu 322 can appear in response to user input corresponding to selection of the highway 220. The dropdown menu 322 can have user selectable inputs 325 for selecting geographical locations such as mile markers 1, 2, and 3 on highway 220 (labeled “Milemark 1”, “Milemark 2” and “Milemark 3”, respectively). Accordingly, if Milemark 1 is selected, an upper bound 335 can be placed at a mile marker of highway 220 corresponding to Milemark 1. If Milemark 3 is selected, a lower bound 340 can be placed at another mile marker of highway 220 corresponding to Milemark 3. Thus, a particular region of interest can be ascertained from the selection of the highway 220, as well as an upper bound 335 and lower bound 340. The particular region of interest characterized by user input in the GUI 300 can be converted into geographical coordinates by the policy management engine 134 of FIG. 1.

The particular region of interest on the highway 220 is bounded by the upper bound and lower bound, as specified by the user input. As illustrated, each individual geospatial shape of the plurality of geospatial shapes 200 is insufficient to cover the particular region of interest. Moreover, to cover the particular region of interest, the three geospatial shapes 200 encompassing the particular region of interest are needed to create a unique boundary. Particularly, the unique boundary to cover the particular region of interest in FIG. 3 is a union, such that the particular region of interest is sufficiently covered.

Referring back to FIG. 1, the policy management engine 134 can provide a request indicating a particular region of interest to the boundary coordinator 132 and receive each calculated geospatial shape from the geospatial shape generator 124. In response to receipt of the request from the policy management engine, the boundary coordinator 132 can query a geographic information system (GIS) 136 to determine which geospatial shapes encompass the particular region of interest. In response to the query, the GIS 136 can return boundaries of the geospatial shapes, as well as the particular region of interest, to the boundary coordinator 132. More particularly, the boundary coordinator 132 can generate the query using an application programming interface (API) call to the GIS 136. The query for each geospatial shape can include the geographic boundaries of each of the respective geospatial shapes. Moreover, in some examples, the boundary coordinator 132 can provide multiple queries to the GIS 136, such as one query per type of particular region of interest.

In response to the query, the GIS 136 can return boundaries of the geospatial shapes, as well as the particular region of interest, to the boundary coordinator 132. The boundary coordinator 132 can store the geospatial shape, along with the boundaries of the particular region of interest, in a geospatial shape database 140. Moreover, the boundary coordinator 132 is employed to generate a unique boundary when the particular region of interest is encompassed by two or more geospatial shapes. A unique boundary generated by the boundary coordinator 132 can be a combination of (e.g., a union or an intersection) of two or more geospatial shapes that encompass the particular region of interest. Accordingly, in some examples, the area of a unique boundary, that is a union of geospatial shapes, is substantially the same as the summation of each of the geospatial shapes of the unique boundary. The boundary coordinator 132 can store a generated unique boundary in a geospatial shape database 140.

The geospatial shape database 140 can be implemented, for example as a relational database, such as a search and query language (SQL) database. Moreover, although the geospatial shape database 140 is illustrated as being stored locally in the memory 108, in other examples, the geospatial shape database 140 can be stored on external system and accessed by the geospatial shape server 120 remotely. The geospatial shape database 140 can store records for each geospatial shape generated for each cell sector identified in the cell sector data. Each such record can include, for example the boundaries of a respective geospatial shape, the boundaries of the particular region of interest within the boundaries of the respective geospatial shape and a location (latitude and longitudinal coordinates) associated with the particular region of interest. The boundary coordinator 132 can preprocess the records in the geospatial shape database 140 to assign each particular region of interest to a unique boundary generated by the boundary coordinator.

Accordingly, the boundary coordinator 132 can associate a particular region of interest with a unique boundary that is a combination of geospatial shapes, such as the geospatial shapes 200 of FIG. 3. Accordingly, the boundary coordinator 132 can store the relationship between the unique boundary and the particular region of interest in the geospatial shape database 140 of FIG. 1. Thus, the preprocessing executed by the boundary coordinator 132 can assign a unique boundary (or a combination of geospatial shapes) to a particular region of interest specified by the policy management engine 134.

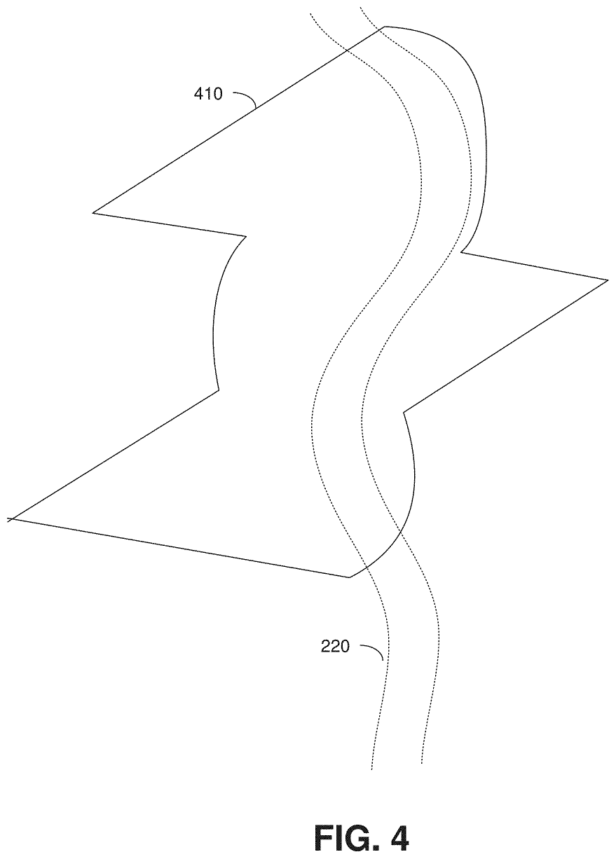

FIG. 4 illustrates an example of a unique boundary 410. For purposes of simplification and explanation, the highway 220 has the reference number as the highway 220 of FIGS. 2 and 3. Accordingly, the unique boundary 410 illustrates a union of the plurality of geospatial shapes 200 of FIGS. 2-3 to sufficiently cover the particular region of interest. Accordingly, during a multiparty emergency incident, emergency services calls made in the unique boundary can be routed to a particular PSAP, such as a highway patrol.

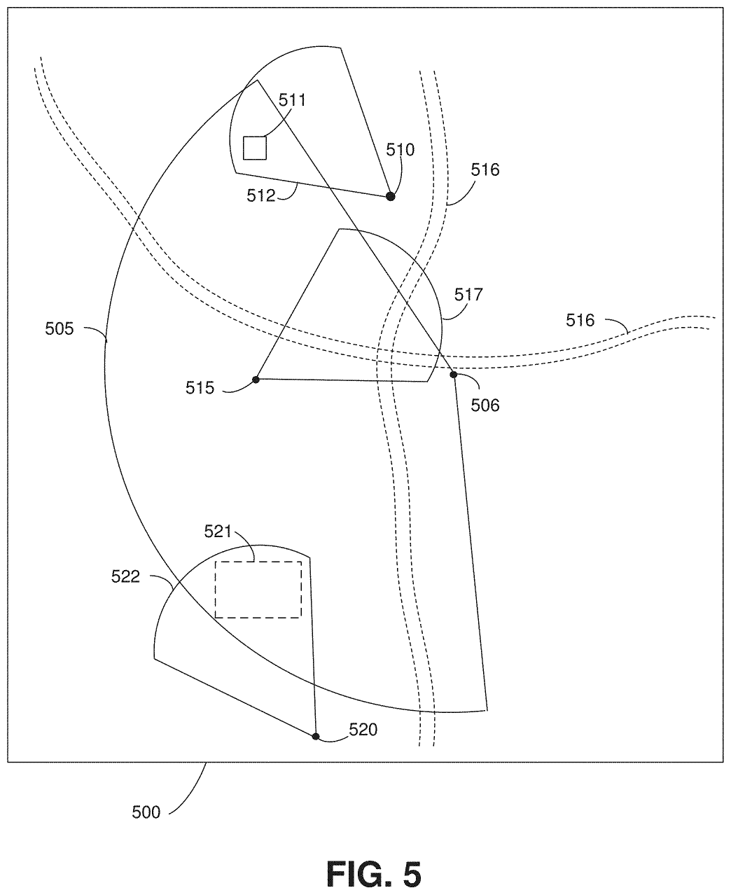

FIG. 5 illustrates a map 500 including a large geospatial shape 505. As illustrated, the large geospatial shape 505 represents a cell sector 506 that has a radius of communication that is miles long and covers a geographic region that encompasses a plurality of other cell sector service areas. A call served by a cell sector 506 represented by the geospatial shape 505 is forwarded to a particular PSAP, such as a PSAP corresponding to a suburban emergency dispatch. However, given the size of the large geospatial shape 505, calls originating from different areas with the large geospatial shape 505 can be handled by a more appropriate PSAP.

For example, a cell sector 510 could be located near an urban area with a university campus 511, a cell sector 515 can be located near a junction of highways 516 and a cell sector 520 can be located in a rural area 521. Thus, the cell sector 510 can route calls to a PSAP corresponding to campus emergency dispatch, the cell sector 515 can route calls to a PSAP corresponding to highway patrol, and the cell sector 520 can route calls to a PSAP corresponding to rural emergency dispatch. As illustrated in FIG. 5., the radius of communication of the cell sectors 510, 515 and 520 are each represented by corresponding small geospatial shapes 512, 517, and 522 that overlap with the geospatial shape 505. Particularly, the university campus 511 can be encompassed by the large geospatial shape 505 and the small geospatial shape 512 corresponding to the cell sector 510 near the university campus 511. The junction of highways 516 can be encompassed by the large geospatial shape 505 and the small geospatial shape 517 corresponding to the cell sector 515 near the junction of highways 516. Similarly, the rural area 521 can be encompassed by the large geospatial shape 505 and the small geospatial shape 522 corresponding to the cell sector 520 near the rural area 521.

Accordingly, an emergency services call that originates in an area overlapped by both the small geospatial shape 512 and the large geospatial shape 505 would be routed by the cell sector 506 to the PSAP corresponding to the suburban emergency dispatch, if handled by the cell sector 506 of the large geospatial shape 505. Particularly, each cell sector 506 can have a predetermined PSAP to route emergency service calls to in the event of a multiparty incident based on the carrier network and/or communication protocol of the cell sector 506, for example. However, an emergency services call originating in the small geospatial shape 512 to report a multiparty emergency incident at the university campus 511 would need to be transferred. That is, a PSAP corresponding to the campus police would likely be better equipped to handle an emergency services call near the university campus 511, rather than the suburban emergency dispatch. Similarly, an emergency services call that originates in an area overlapped by both geospatial shapes 517 and 505 and is routed by cell sector 506 would be routed to the PSAP corresponding to the suburban emergency dispatch and require a transfer to the PSAP corresponding to highway patrol.

Moreover, a union of any of the small geospatial shapes 512, 517 or 522 and the large geospatial shape 505 would not render a unique boundary capable of reducing calls needed to be transferred in the example illustrated by FIG. 5. Rather, a unique boundary that is an intersection, such as an intersection of the small geospatial shape 522 corresponding to the cell sector 520 near the rural area 521 and the large geospatial shape 505, would reduce the amount of transfers of emergency services made to related to a multiparty incident at the rural area 521. Particularly, the intersection of two geospatial shapes is the area that is covered by both geospatial shapes. Accordingly, the intersection of the small geospatial shape 522 and the large geospatial shape 505 that both encompass the rural area 521 renders a unique boundary that sufficiently covers the rural area 521 and reduces excessive coverage area. Thus, emergency services call originating within the unique boundary related to a multiparty emergency incident at the rural area 521 would be less likely to need to transfer. Rather, a call that originates within an area that is outside of the unique boundary would be routed to a PSAP based on the geographical shape that the call originates, such that the geographical shape includes cell sector data that indicates a particular network carrier and/or protocol.

Referring back to FIG. 1, as noted, the boundary coordinator 132 can be employed to generate a unique boundary that is a combination (e.g., a union or intersection) of two or more geospatial shapes that encompass the particular region of interest. A unique boundary that is an intersection of two or more geospatial shapes has an area that is encompassed by both of the two or more geospatial shapes. Moreover, a unique boundary that is an intersection of two or more geospatial shapes is inherently smaller than a unique boundary that is a union of the two or more geospatial shapes, as an intersection is an area shared by each geospatial shape and a union is the summation of each geospatial shape. Accordingly, a unique boundary that is an intersection of two or more geospatial shapes can provide higher accuracy in routing calls to a particular PSAP. Rather, a call that originates within an area that is outside of the unique boundary would be routed to a PSAP based on the geographical shape that the call originates, such that the geographical shape includes cell sector data that indicates a particular network carrier and/or protocol. Furthermore, in some examples, the boundary coordinator 132 can automatically determine whether a union or intersection of geospatial shapes would provide excessive area and sufficient coverage of the particular area of interest based on geographical data provided by the GIS 136. Thus, the boundary coordinator 132 can automatically generate and store a unique boundary that reduces the likelihood of transferred emergency service calls reporting a multiparty incident at a particular region of interest. Alternatively, a GUI provided by the policy management engine 134 can provide user controls to select a union or intersection. In response, the policy management engine 134 can provide data indicating a union or intersection to the boundary coordinator 132 to generate the unique boundary.

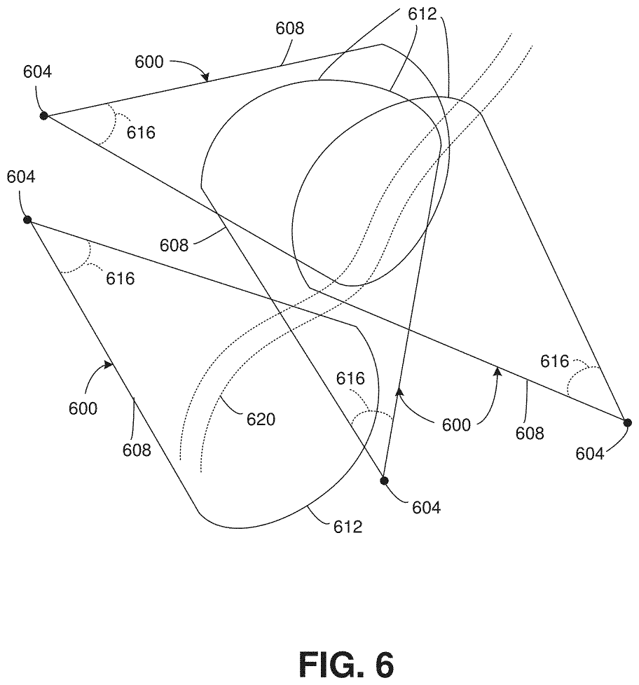

FIG. 6 displays another plurality of geospatial shapes 600. For purposes of simplification of explanation, the geospatial shapes 600 are similar to the geospatial shapes 200 of FIGS. 2-3. That is, the geospatial shapes 600 include a point 604, edge 608, base 612 and beam width 616, similar to the point 204, edge 208, base 212 and beam width 216 of the geospatial shapes 200 of FIGS. 2-3. As illustrated, the geospatial shapes 600 of FIG. 6 are arranged differently than the geospatial shapes 200 of FIGS. 2-3. The highway 620 as illustrated in FIG. 6 can be at the same location as the highway 220 of FIGS. 2-3, or the highway 620 can represent a different location than highway 220 as illustrated in FIGS. 2-3.

Again, each of the geospatial shapes 600 of cell sector partitions (cell sector wedges) can correspond to different telecommunications providers and each of the geospatial shapes 200 can be associated with a different PSAP. In a multiparty emergency incident, some (or all) emergency services calls originating within any of the geospatial shapes 200 should be routed to an emergency handling system such as a particular PSAP, and more specifically, to a particular answer group within the particular PSAP. As depicted in FIG. 6, multiple geospatial shapes can be overlapping, such that a emergency services call originating from an area encompassed by overlapping geospatial shapes could be routed to any of a plurality of PSAPs corresponding to the overlapping geospatial shapes 600. For example, an emergency services call originating within the overlapping area can be handled by a given cell sector corresponding to one of the overlapping geospatial shapes 600. Accordingly, the given cell sector can route the emergency services call to a given PSAP associated with the given cell sector. The given PSAP could be an emergency dispatch for a municipality, for example. However, the area overlapped by the geospatial shapes is a segment of a highway 220, such that a PSAP corresponding to a highway patrol would be more appropriate.

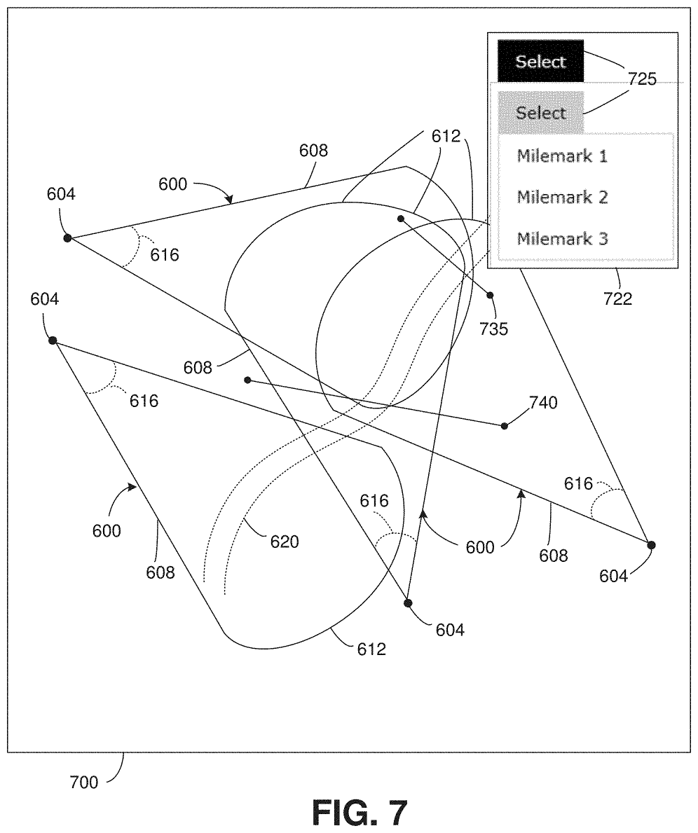

FIG. 7 illustrates another instance of a GUI 700 provided by the policy management engine 134 of FIG. 1 that displays the map, or view, of the geographical area as illustrated in FIG. 6. Accordingly, the reference numbers of the geospatial shapes 600 and the highway 620 of FIG. 6 are repeated for purposes of simplification of explanation, although in some examples, the GUI 700 omits the geospatial shapes 600. Moreover, the GUI 700 can include controls for a user to pan and zoom to highway 620. Alternatively, the GUI 700 can include an input field for user input to populate data fields that define geographical coordinates to identify a highway 620. The GUI 700 includes a dropdown menu 722 that can appear in response to the user input indicating selection of the highway 620. The dropdown menu 722 includes user selectable inputs 725 for selecting geographical locations such as mile markers 1, 2, and 3 on highway 620. If the user selects Milemark 1 via the user selectable inputs 725, an upper bound 735 can be created on the GUI 700 at a milemarker of highway 620 corresponding to Milemark 1. Additionally, if the user selects Milemark 2 via another user selectable input 325, a lower bound 740 can be created on the GUI 700 at another milemarker of highway 620 corresponding to Milemark 2. Thus, a particular region of interest can be ascertained from the selection of the highway 620, as well as the upper bound 735 and lower bound 740.

The particular region of interest of the highway 620 between the upper bound 735 and the lower bound 740 is encompassed by three of the geospatial shapes 600, as illustrated in FIG. 7. Accordingly, a union of the three geospatial shapes 600 encompassing the particular region of interest would render a unique boundary that sufficiently covers the particular region of interest. However, a union of the three geospatial shapes 600 encompassing the particular region of interest would cover an excessive amount of area beyond that of the particular region of interest. Rather, an intersection of the three geospatial shapes 600 encompassing the particular region of interest can render a unique boundary that sufficiently covers the particular region of interest and simultaneously reduce the amount of excessive area compared to a union. Although not illustrated in FIG. 7, the GUI 700 can further include controls to select a union or intersection used to generate a unique boundary.

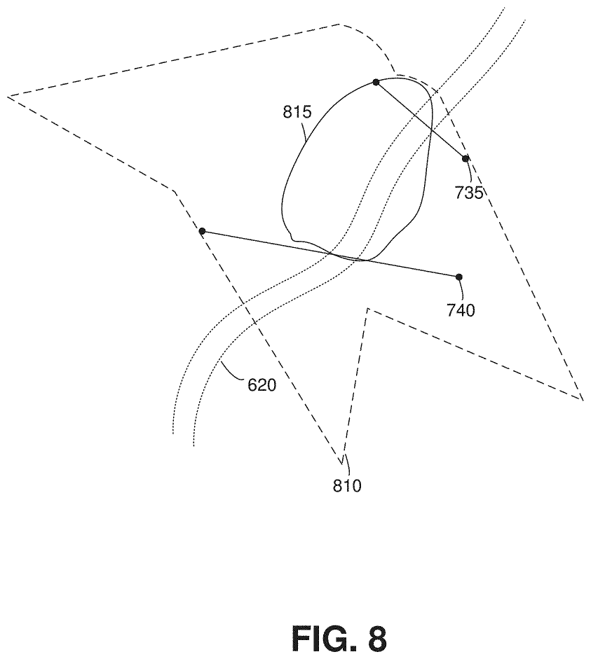

FIG. 8 illustrates examples of unique boundaries. For the purpose of simplification of explanation, the upper bound 735, the lower bound 740 and the highway 620 are included to denote the same structure. As previously explained in reference to FIG. 7, the area of the highway 620 between the upper bound 735 and the lower bound 740 is a particular region of interest, which can be defined by a user via a GUI. Accordingly, the particular region of interest is encompassed by three geospatial regions. A union of the three geospatial regions would result in a unique boundary 810, that is illustrated as a dashed line. An intersection of the three geographical regions would result in a unique boundary 815, which is illustrated as a solid line.

As illustrated in FIG. 8, the unique boundary 810 and the unique boundary 815 sufficiently cover the particular region of interest. Additionally, both the unique boundary 810 and unique boundary 815 cover excessive area, or area that is beyond the particular region of interest of the highway 620. Because a given unique boundary is used to forward emergency calls to a particular PSAP, excessive area of the given unique boundary can result erroneous emergency calls forwarded to the particular PSAP. As illustrated in FIG. 8, the unique boundary 810 that is a union, or summation of the three geospatial shapes, includes substantially more excessive area than the unique boundary 815, which is an intersection of the three geospatial shapes. Therefore, in some examples as depicted in FIG. 8, generating a unique boundary that is an intersection, rather than a union, can provide higher accuracy in routing calls to a particular PSAP. Again, a call that originates within an area that is outside of the unique boundary would be routed to a PSAP based on the geographical shape that the call originates, such that the geographical shape includes cell sector data that indicates a particular network carrier and/or protocol.

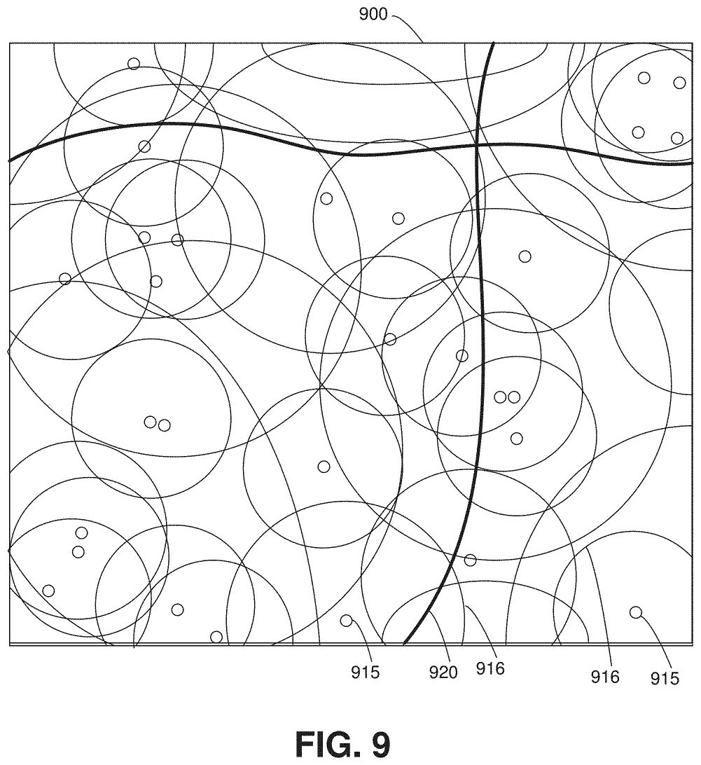

FIG. 9 illustrates a GUI 900 displaying a plurality of cell sectors 915, each cell sector 915 has a radius of communication 916. Because FIG. 9 illustrated the complexity of a plurality of cell sectors 915 and corresponding radii of communication 916, only two cell sectors 915 and radii of communication 916 are labeled. As previously explained, each cell sector corresponds to a given wireless carrier (e.g., VERIZON®, T-MOBILE®, SPRINT®, AT&T®, etc.) and communicates via a particular communication protocol (e.g., 3G, 4G, 4G Long Term Evolution (LTE), 5G, etc.). As seen in FIG. 9, a given segment of a highway 920 can be encompassed by tens, or even hundreds, of cell sectors 915. The GUI 900 demonstrates the myriad of cell sectors in a relatively small geographical area. Thus, the complexity illustrated in the GUI 900 of the given segment of the highway 920 is nearly unintelligible. Consequently, manually determining an area for a multiparty incident and selecting a corresponding PSAP for a combination of cell sectors in the GUI 900 would be error prone and extremely slow. Accordingly, by employing a unique boundary that is an intersection of tens, or possibly hundreds of geospatial shapes associated with the cell sectors, a given particular region of interest can be sufficiently covered with the unique boundary. Additionally, the excessive area of the unique boundary can be substantially reduced where more geospatial shapes of the cell sectors encompass the particular region of interest. That is, a unique boundary that is an intersection is inherently smaller than the geospatial shapes that comprise the intersection, or radius of communication 916 of cell sectors 915, because the unique boundary encompasses an area that is encompassed by each of the geospatial shapes. Accordingly, the unique boundary can be more precise in covering a particular area of interest, such as a given segment of the highway 920, by employing more geospatial shapes.

Referring back to FIG. 1, the system 100 can include R number of origin networks 150 that each communicate with K number of end-user devices 154, where R and K are each integers greater than or equal to one. Moreover, different origin networks 150 can have a different number (or the same number) of end-user devices 154.

Each origin network 150 can be representative of a telecommunications network, such as a wireless communications network. Each end-user device 154 is operated by an end-user, which end-user can be referred to as a caller. The end-user device 154 can be a mobile device, such as a wireless phone operating on a carrier network (e.g., a smart phone, a feature phone, etc.), a Voice over Internet Protocol (VoIP) phone, etc. As an alternative, each end-user device can be referred to as user equipment (UE). Each of the R number of origin networks 150 can include an emergency gateway 152 to route emergency calls from respective end-user devices 154. Each emergency gateway 152 (or some subset thereof) can be configured as a router (e.g., a hardware device). In some examples, each emergency gateway 152 (or some subset thereof) can be implemented as a distributed computing device (e.g., an instance of virtual hardware) executing in a computing cloud. In other examples, each emergency gateway 152 (or some subset thereof) can be implemented as a single instance of hardware.

Each emergency gateway 152 can include the functionality and/or structure of a positioning center. The positioning center of each respective emergency gateway 152 can be representative of nearly any non-landline positioning center, including a Mobile Positioning Center (MPC), a Gateway Mobile Positioning Center (GMLC), location retrieval function (LRF) and/or an emergency routing services (ERS) node, a VoIP Positioning Center (VPC), etc. The nodes of the system 100 (including the emergency gateway 152) can communicate with standard protocols, such as the HTTP (Hypertext Transfer Protocol)-Enabled Location Deliver Protocol (HELD) and/or the Mobile Location Protocol (MLP).

Each end-user device 154 can be employed by the respective caller to initiate an emergency services call. The emergency services call can be, for example, a voice 9-1-1 call, a 9-1-1 text (or short) message (e.g., a short message service (SMS) message or a real-time text (RTT) message), etc. The emergency services call can be a request for immediate emergency assistance, including ambulatory service, police assistance, fire department assistance, assistance on waterways or some combination thereof. In some examples, the end-user device 154 may be issued or controlled by a particular enterprise (e.g., a business) that maintains its own call center (e.g., a secondary call center) for handling emergency services calls.

Each emergency services call can be routed to a particular PSAP 160 of G number of PSAPs 160 via a public safety network 164 in a manner described herein, where G is an integer greater than one. In particular, each end-user device 154 can be connected to a node of a respective origin network 150, such as a primary service delivery node (PSDN). In examples where a particular end-user device 154 is a mobile phone operating on a carrier network, a respective origin network 150 can include a Mobile Switching Center (MSC). In examples where the end-user device 154 is a VoIP phone, the respective origin network can include a VoIP service provider (VSP). The respective origin network 150 can be connected to the public safety network 164. The public safety network can be representative of a collection of telephony routers, including, but not limited to a cell tower, selective routers, etc. The public safety network 164 can also include routing and location nodes, such as an emergency services routing proxy (ESRP) 168, an additional data source 172 and an emergency call routing function (ECRF) 176. The public safety network 164 can be implemented as part of the Public Switched Telephone Network (PSTN), the Internet and/or as part of a private network (e.g., a wireless carrier network).

To illustrate operation of the system 100, an extended example is provided (hereinafter, “the given example”). In the given example, a given end-user device 154 is employed to make a given emergency services call form a given end-user device 154 connected to a given origin network 150 (e.g., end-user device 1 of origin network 1). In response, the given origin network 150 can provide a notification of the emergency services call to a given emergency gateway 152 of the given origin network 150. In some examples, signaling for the given emergency services call can include device-based location information (e.g., geographic coordinates, such as latitude and longitude coordinates). The device-based location information can be determined by the given end-user device 154 (e.g., with a global positioning system (GPS)) or in concert with the origin network 150 (e.g., through triangulation). Further, in some situations, the device-based location information can include an altitude. In other examples, the device-based location information can be omitted.

In response to the notification of the emergency services call, the given emergency gateway 152 can be configured to query the ESRP 168 of the public safety network 164 for location information of the given emergency services call. In response, the ESRP 168 can provide the location information (e.g. a cell sector identifier) to the given emergency gateway 152, and the given emergency gateway 152 can forward signaling, such as a Session Initiation Protocol (SIP) invite for the given emergency services call to the ESRP 168.

In response to the signaling, the ESRP 168 can query the additional data source 172 of the public safety network 164 for geographical coordinates for the given end-user device 154. In response, the additional data source 172 can return location information including latitude and longitude coordinates (e.g., geographic coordinates) for the given end-user device 154. In response to receipt of the location information from the additional data source 172, the ESRP 168 can execute a policy decision for the given emergency services call. The policy can be based, for example on the presence or absence of device location information in the given emergency services call. The policy can dictate selection of location information. More particularly, the policy can dictate whether to select the location information (the latitude and longitude coordinates) provided from the additional data source 172 or to select the device-based location information (if included) to route the given emergency services call. In some examples, the policy can be based on a timestamp included with the device-based location information. Upon determining the policy decision, the ESRP 168 can query the ECRF 176 for an identity of a particular PSAP 160 or a PSAP answer group 180 of the G number of PSAPs 160 to handle the given emergency services call with the selected location information. The identity of the particular PSAP 160 or the PSAP answer group 180 can be provided as a uniform resource identifier (URI). As one example, the ECRF can be a Location to Service Translation (LoST) server. In such a situation the query to the ECRF 176 can be formatted as a Location to Service Translation (LoST) query that includes the selected location information (e.g., latitude and longitude) of the given end-user device 154.

In response to the query from the ESRP 168 (e.g., the LoST query), the ECRF 176 can return a URI for a given PSAP 160 or a given PSAP answer group 180 that can handle the given emergency services call. In response, the ESRP 168 can forward the signaling for the given emergency services call to the given PSAP 160, such that the given emergency services call is connected to an operator of the PSAP 160.

Most emergency calls can be handled in a manner similar to the given emergency services call. However, in situations where a multiparty emergency incident occurs, multiple calls to the G number of PSAPs (or some subset thereof) are likely made to report the multiparty emergency incident. For instance, if a traffic accident with multiple cars occurs on a segment of highway, many calls from end-user devices 154 that are one or near the segment of highway will be made. Some of these calls are likely to be from different origin networks 150 (e.g., different telecommunication networks). Moreover, with standard operating procedures, these calls may be routed wrongly and need to be transferred, which can increase emergency response time at a detriment to public safety.

To address multiparty emergency incidents the geospatial shape server 120 can include a call route control 170. The call route control 170 can receive data indicating the particular region of interest from the policy management engine 134, as well as the associated unique boundary from the geospatial shape database 140. Moreover, the call route control 170 can receive data from the policy management engine 134 indicating a preferred PSAP for emergency calls originating within the unique boundary associated with the particular region of interest.

Additionally, the call route control 170 can include, for example a client portal, such as a web portal for the geospatial shape server 120. Each of the G number of PSAPs 160 (or some subset thereof) can operate a client 174 (e.g., a web client or a dedicated client) for accessing the call route control 170 of the geospatial shape server 120. The call route control 170 can provide access to the geospatial shape database 140 which can provide a selectable list of unique boundaries and particular regions of interest. As an example, the call route control 170 can provide a list that includes the particular region of interest of highway 220 of FIG. 3. The client 174 of each PSAP 160 can select a particular region of interest from the list of regions of interest and associate the multiparty emergency incident with a particular emergency handling system. Accordingly, emergency calls originating from an end-user device 154 within the unique boundary of the selected particular region of interest are likely to be routed to the particular emergency handling system, such as the corresponding PSAP 160.

Additionally or alternatively, the web portal of the call route control 170 can provide access to a GUI provided by the policy management engine 134 to enable a PSAP 160 to define a particular region of interest. As an example, it is possible that the geospatial shape database 140 does not have a particular region of interest that is appropriate for the client to select, based on the needs or nature of the multiparty emergency incident. Accordingly, the call route control 170 can provide the client with a GUI, as illustrated in FIG. 3, such that the client 174 can define a new particular region of interest using the GUI, as well as a particular emergency handling system (e.g., PSAP 160). Thus, the client 174 can provide the policy management engine 134 with data defining the new particular region of interest via the call route control 170, which is then received by the boundary coordinator 132. Subsequently, the boundary coordinator 132 can generate a unique boundary associated with the new particular region of interest, as well as store the association of the unique boundary and new particular region of interest in the geospatial shape database 140. Therefore, the call route control 170 can provide the ECRF 176 with a particular emergency handling system for emergency calls originating in the unique boundary associated with the new particular region of interest.

As an example of operation, suppose that a PSAP operator (e.g., a supervisor) of the first PSAP 160 (PSAP 1) employs the client 174 to select a particular public interest structure (e.g., a highway segment) to initiate a request to the call route control 170 to route emergency services calls for the particular public interest structure in response to a report of a multiparty emergency incident. Additionally, in some examples, the request can include data identifying an emergency handling system, such as a PSAP answering group 180 (PSAP AG) or another type of emergency handling system that is designated to handle calls for the multiparty emergency incident. In other examples, the request can omit the information identifying the particular emergency handling system. In response, the call route control 170 can query the geospatial shape database 140 for one or more geospatial shapes or a combination (union or intersection) of geospatial shapes that are associated with the selected public interest structure (e.g., the highway segment), and designate the one or more geospatial shapes or a combination of geospatial shapes as an emergency region. Moreover, the call route control 170 can provide a GIS reference to the ECRF 176 and/or to other nodes of the public safety network 164. The GIS reference can include data that characterizes the boundaries of the emergency region. The GIS reference can be a latitude and longitude coordinate or a set of latitude and longitude coordinates. The GIS reference provided to the nodes of the public safety network 164 (e.g., the ECRF 176) cause emergency calls originating within the particular region of interest to be routed to the first PSAP 160 and/or the PSAP answering group 180 of the first PSAP 160. The GIS reference can include the unique boundary in the Extensible Markup Language (XML) format or the GeoJSON (Geo JavaScript Object Notation) format or another standard format.

Accordingly, the system 100 can process emergency calls for the multiparty emergency incident in a manner similar to the given emergency call in the given example. However, during the multiparty emergency incident in contrast to the given example, in some situations where the latitude and longitude (returned by the additional data source 172) is within the unique boundary and the signaling associated with the emergency services call does not include device-based location (e.g., latitude and longitude coordinates determined by the end-user device 154), the ECRF 176 can return a URI for an emergency handling system, namely the first PSAP 160 or the PSAP answering group 180 within the first PSAP 160. Stated differently, in response to the query from the ESRP 168 (e.g., a LoST query) that identifies latitude and longitudinal coordinates within the unique boundary, the ECRF 176 can return a URI for the emergency handling system (e.g., the first PSAP 160 or the PSAP answering group 180 within the first PSAP 160). In this manner, emergency calls that are likely related to the multiparty emergency incident are efficiently transferred to the appropriate PSAP 160 and/or the appropriate PSAP answering group 180, thereby reducing a number of transfers needed to provide information and/or dispatch emergency services for the multiparty emergency incident.

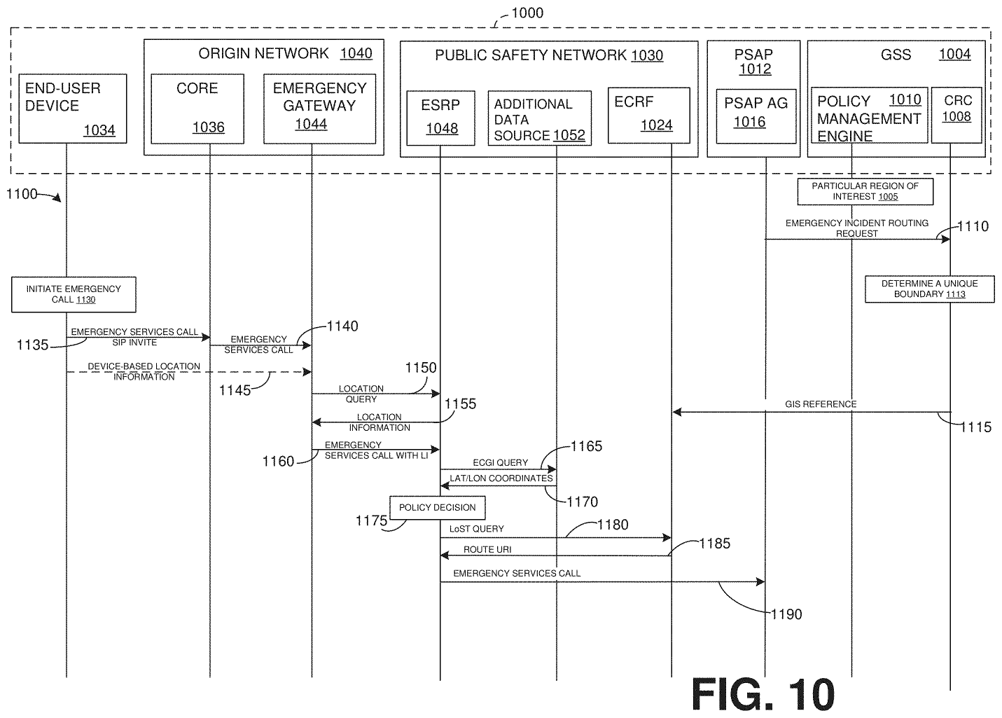

FIG. 10 illustrates a timing diagram for a system 1000 for executing a method 1100 to route emergency services calls related to a multiparty emergency incident. The system 1000 can include nodes that communicate over a public network, such as the Internet, a private network, such as a wireless carrier network or a combination thereof.

The system 1000 can include a geospatial shape server 1004 (labeled GSS), such as the geospatial shape server 120 of FIG. 1. In the method 1100, it is presumed that the geospatial shape server 1004 has preprocessed a geospatial shape database (e.g., the geospatial shape database 140 of FIG. 1) to associate each of a plurality of particular areas of interest with one or more unique boundaries. Additionally, it is presumed that in the method 1100, a multiparty emergency incident has been reported for a particular region of interest.

The geospatial shape server 1004 includes a call route control 1008 (labeled CRC) that is configured to communicate with a policy management engine 1010 of the geospatial shape server 1004. The call route control 1008 can be the call route control 170 of FIG. 1 and the policy management engine 1010 can be the policy management engine 134 of FIG. 1. Accordingly, the policy management engine 1010 can provide a user with a GUI to select, or provide data, indicating a particular region of interest. Moreover, the policy management engine can send information indicating the particular region of interest to the call route control 1008. At 1105, the policy management engine 1010 is implemented to define a particular region of interest. Moreover, the policy management engine 1010 can further communicate information to the call route control 1008 indicating a particular PSAP to route calls to that originate within the particular region of interest. Alternatively, the call route control 1008 can be configured/programmed to provide a client portal (e.g., a web portal or a dedicated client portal) for the geospatial shape server. Particularly, the client portal can provide access to a remote user to interact with the GUI provided by the policy management engine 1010 to indicate a particular region of interest.

The system 1000 also includes a PSAP 1012 that represents an instance of a PSAP 160 of FIG. 1. The PSAP 1012 can include a client (e.g., a web client or a dedicated client) for accessing the call route control 1008. The client can be employed to implement an instance of the client 174 of FIG. 1. Alternatively at 1105, the client can be employed to provide information identifying a particular region of interest using a GUI provided by the policy management engine 1010, as well as indicate a particular PSAP answering group 1016 (labeled PSAP AG) to handle the multiparty emergency incident. At 1110, a given PSAP is employed to provide an emergency incident routing request originating from the particular region of interest ascertained by the policy management engine 1010 at 1105. Particularly, the emergency incident routing request identifies the location of the emergency incident, as well as a particular PSAP answering group 1016 that handled the emergency incident. In other examples, the information identifying the PSAP answering group 1016 is omitted. Alternatively, the particular PSAP answering group 1016 that handled the call can also communicate to the call route control 1008 a particular region of interest defined using the client provided by the call route control 1008.

In response, at 1113, the call route control 1008 employs the received particular region of interest to query a geospatial shape database (e.g., the geospatial shape database 140 of FIG. 1) to determine a unique boundary associated with the particular region of interest. Accordingly, the query of the geospatial shape database from the call route control 1008 returns a unique boundary associated with the particular region of interest. The particular region of interest can be a geospatial shape, or a combination of geospatial shapes. Particularly, the unique boundary can be a union of a plurality of geospatial shapes as illustrated in FIG. 4, or an intersection of a plurality of geospatial shapes as illustrated in FIG. 7. As previously explained, geospatial shape server 1004 preprocesses geospatial shapes and identifies an appropriate unique boundary for the particular region of interest.

At 1115, the call route control 1008 provides a GIS reference for the emergency incident to an ECRF 1024 of a public safety network 1030. In other examples, the GIS reference can be provided to additional or alternative nodes of the public safety network 1030. The public safety network 1030 can be employed to implement the public safety network 164 of FIG. 1, and the ECRF 1024 can be employed to implement the ECRF 176 of FIG. 1. The GIS reference can include the unique boundary of the particular region of interest, such that emergency calls originating within the unique boundary can be forwarded to a particular PSAP. In some examples, the unique boundary can be provided in XML or geoJSON format to the ECRF 1024. Moreover, in some examples, the GIS reference (and/or other messaging) can include a URI of the emergency handling system, namely the particular PSAP answering group 1016, which can be identified by the policy management engine 1010. In other examples, this information pertaining to the URI of the emergency handling system can be omitted.

The system 1000 can include an end-user device 1034. The end-user device 1034 can be implemented, for example, as a VoIP phone (mobile or fixed-based), a wireless phone (e.g., a smart phone or feature phone operating on a carrier network), etc. The end-user device 1034 can be employed to implement an instance of the end-user device 154 illustrated in FIG. 1. The emergency services call can be, for example, a voice 9-1-1 call, a 9-1-1 text (or short) message (e.g., a short message service (SMS) message or a multimedia service (MMS) message), etc.

At 1130, the end-user device 1034 can be employed to initiate an emergency services call (e.g., a 9-1-1 voice or text call in North America). A user of the end-user device 1034 can be referred to as a caller (of the emergency services call). At 1135, the emergency services call can be implemented as signaling for a SIP invite that is provided to a core 1036 of an origin network 1040 (e.g., at a primary service delivery node), which can be implemented as an MSC on a wireless subscriber network that communicates with the end-user device 1034 or a VSP that communicates with the end-user device 1034 on a TCP/IP network. The core 1036 can detect that the call is an emergency services call (e.g., by detecting that the call is directed to an emergency services contact center if the call has “9-1-1” digits). At 1140, the core 1036 can process the emergency services call and route/forward the emergency services call to an emergency gateway 1044 of the origin network 1040. The emergency gateway 1044 can be implemented with the emergency gateway 152 of FIG. 1 and can be representative of telephony network components and/or Internet network components needed to route or provide routing information to connect the emergency services call to an appropriate call handling facility (e.g., a PSAP). Additionally, in some examples, at 1145, the end-user device 1034 provides the emergency gateway 1044 with device-based location information (e.g., latitude and longitude coordinates). In other examples, the operation at 1145 are omitted.

At 1150, the emergency gateway 1044 queries an ESRP 1048 (e.g., the ESRP 168 of FIG. 1) for location information based on the signaling (e.g., a SIP invite) of the emergency services call. At 1155, the ESRP 1048 retrieves location information (e.g., a cell sector ID) for the end-user device 1034, and provides the retrieved information to the emergency gateway 1044.

At 1160, the emergency gateway forwards the emergency services call, along with the signaling (SIP invite) to the ESRP 1048. At 1165, the ESRP 1048 executes an E-UTRAN cell global identifier (ECGI) query to an additional data source 1052 (e.g., the additional data source 172 of FIG. 1) based on the cell sector ID provided from the ESRP 1048. In response, at 1170 the additional data source 1052 provides location information including latitude and longitude coordinates for the end-user device 1034. In the example illustrated, it is presumed that the latitude and longitude coordinates returned by the additional data source 1052 are within the unique boundary of the particular region of interest designated by the geospatial shape server 1004.

At 1175, the ESRP 1048 makes a policy decision as to whether to select the location information provided from the additional data source 1052 to route the emergency services call or to select the device-based location information that may or may not be provided at 1145 for routing the emergency services call. In examples where the device-based location is provided, the ESRP 1048 may select the location information provided from the additional data source 1052 if the device-based location information is stale (e.g., the device-based location information has not been updated within a configurable time threshold). In examples where the device-based location is omitted, the ESRP 1048 also selects the location information provided from the additional data source 1052. In still other examples, where the device-based location information is included and has been updated more recently than the time threshold, the ESRP 1048 can select the device-based location information to route the emergency services call. In the method 1100, it is presumed that the ESRP 1048 selects the latitude and longitude coordinates provided from the additional data source 1052.

At 1180, the ESRP 1048 employs the selected location information to generate a LoST query (or other routing query) that is provided to the ECRF 1024. At 1185, the ECRF 1024 returns a URI for the PSAP answering group 1016. At 1190, the emergency services call and the signaling (SIP invite) are provided to the PSAP answering group 1016 identified in the URI to connect the emergency services call with a PSAP operator within the PSAP answering group 1016.

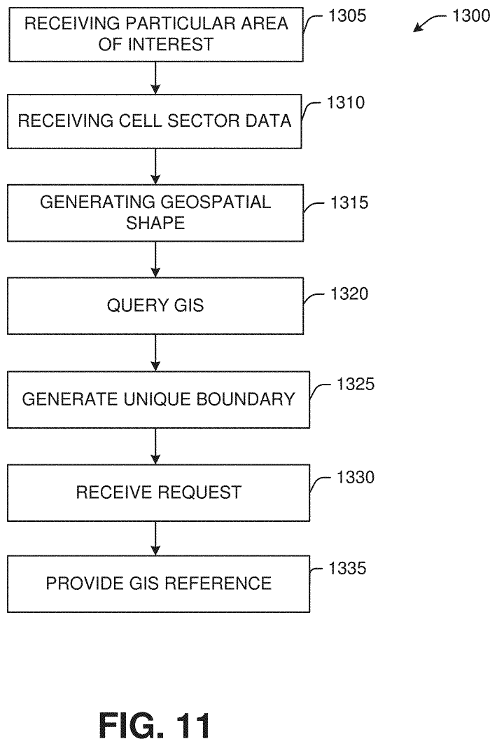

In view of the foregoing structural and functional features described above, example methods will be better appreciated with reference to FIG. 11. While, for purposes of simplicity of explanation, the example method of FIG. 11 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 11 can be implemented as instructions stored in a non-transitory machine-readable medium. The instructions can be accessed by a processing resource (e.g., one or more processor cores) and executed to perform the methods disclosed herein.

FIG. 11 illustrates a flowchart of an example method 1300 for routing emergency services calls for a multiparty emergency incident. The method 1300 can be implemented by a geospatial shape server, such as the geospatial shape server of FIG. 1 and/or the geospatial shape server 1004 of FIG. 10. At 1305, the geospatial shape server can receive a particular region of interest identified in a GUI provided by a policy management engine. The GUI can be the GUI 300 of FIG. 3 and/or the GUI 700 of FIG. 7. The policy management engine can be the policy management engine 134 of FIG. 1. At 1310, the geospatial shape server can receive cell sector data characterizing geocoordinates, a radius (e.g., a coverage radius) and a beam width for each of a plurality of cell sectors. The cell sector data can be provided from an agency, such as the agency 128 of FIG. 1. In some examples, the cell sector data can be a text file, such as a CSV file, a spread sheet, a JavaScript Object Notation (JSON) file or other document.

At 1315, the geospatial shape server can generate a geospatial shape for each of the plurality of cell sectors. The geospatial shape for each respective cell sector characterizes geographical boundaries of a corresponding cell sector partition (e.g., a cell sector wedge or other shape). At 1320, the geospatial shape server queries a GIS (e.g., the GIS 136 of FIG. 1) for geographic coordinates of the particular region of interest within boundaries of each respective geospatial shape.

At 1325, the geospatial shape server can generate a unique boundary for the particular region of interest described by the policy management engine. The unique boundary is a combination of geospatial shapes (e.g., a union or intersection of geospatial shapes) that encompasses the particular region of interest, as identified by the GIS. The unique boundary of the particular region of interest can be stored in a database (e.g., the geospatial shape database 140 of FIG. 1).

At 1330, the geospatial shape server can receive a request to associate a given particular region of interest with an emergency incident (e.g., a multiparty emergency incident, as discussed), which request can be referred to as an emergency incident routing request. At 1335, the geospatial shape server can provide, in response to the request, a GIS reference characterizing a unique boundary of the particular region of interest associated with the emergency incident to a network node of a public safety network that determines destination routing for emergency calls within the emergency region. For instance, the GIS reference can be provided to an ECRF and/or other nodes of the public safety network. The GIS reference can be implemented with latitude and longitude coordinates or a set of latitude and longitude coordinates.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A geospatial shape server operating on a computing platform, the geospatial shape server comprising:
a geospatial shape generator that:
receives cell sector data for cell sectors, wherein the cell sector data characterizes a radius of communication of each cell sector, geocoordinates of cell towers for the cell sectors, wherein a first set of the cell sectors communicate on a first carrier network and a second set of the cell sectors communicate on a second carrier network, different from the first carrier network; and
generates a geospatial shape for the cell sectors, wherein the geospatial shape for each respective cell sector characterizes geographical boundaries of a corresponding cell sector;
a boundary coordinator that:
receives a request from a policy management engine that indicates a particular region of interest; and
queries a Geographic Information System (GIS) for geographic coordinates for the particular region of interest within boundaries of each respective geospatial shape; and
generates a unique boundary that is a combination of geospatial shapes that encompass the particular region of interest identified by the GIS; and
a call route control that:
receives a request to associate the unique boundary with the particular region of interest; and
provides, in response to the request to associate the unique boundary with the particular region of interest, a GIS reference characterizing the unique boundary to a network node of a public safety network that determines destination routing for emergency calls within the particular region of interest.

2. The geospatial shape server of claim 1, wherein the request includes data identifying a particular Public Answering Safety Point (PSAP) of a plurality of PSAPs.

3. The geospatial shape server of claim 1, wherein request includes data identifying a particular answering group of a particular Public Answering Safety Point (PSAP) of a plurality of PSAPs.

4. The geospatial shape server of claim 1, wherein a given geospatial shape is a two-dimensional (2D) shape.

5. The geospatial shape server of claim 1, wherein the particular region of interest includes a highway segment.

6. The geospatial shape server of claim 1, wherein the boundary coordinator receives a request from a policy management engine that indicates a particular region of interest in response to an emergency incident.

7. The geospatial shape server of claim 1, wherein the boundary coordinator stores data characterizing the unique boundary in a database.

8. The geospatial shape server of claim 1, wherein the policy management engine is provided a set of data that defines a particular region of interest.

9. The geospatial shape server of claim 8, wherein the set of data that defines a particular region of interest comprises geographic coordinates.

10. The geospatial shape server of claim 8, further comprising:
a graphical user interface (GUI) comprising:
a view of geospatial shapes for the cell sectors generated by the geospatial shape generator; and
a menu that allows entry of user input to populate the set of data that defines the particular region of interest.

11. The geospatial shape server of claim 1, wherein the unique boundary is an intersection of each geospatial shape that bounds the particular region of interest identified by the GIS.

12. The geospatial shape server of claim 1, wherein the unique boundary is a union of each geospatial shape that bounds the particular region of interest identified by the GIS.

13. The geospatial shape server of claim 1, wherein the call route control provides data characterizing a uniform resource identifier (URI) of a particular emergency handling system for the emergency incident to an emergency call routing function (ECRF).

14. A non-transitory machine readable medium storing machine executable instructions, the machine executable instructions comprising:
a geospatial shape generator that:
receives cell sector data for cell sectors, wherein the cell sector data characterizes a radius of communication of each cell sector, a beam width for each cell sector, geocoordinates of cell towers for the cell sectors, wherein a first set of the cell sectors communicate on a first carrier network and a second set of the cell sectors communicate on a second carrier network, different from the first carrier network; and
generates a geospatial shape for the cell sectors, wherein the geospatial shape for each respective cell sector characterizes geographical boundaries of a corresponding cell sector;
a boundary coordinator that:
receives a request from a policy management engine that indicates a particular region of interest;
queries a geographic information system (GIS) for geographic coordinates for the particular region of interest within boundaries of each respective geospatial shape; and
generates a unique boundary that is a combination of geospatial shapes that encompass the particular region of interest identified by the GIS; and
a call route control that:
receives a request to associate the unique boundary with the particular region of interest; and
provides, in response to the request to associate the unique boundary with the particular region of interest, a GIS reference characterizing the unique boundary to a network node of a public safety network that determines destination routing for emergency calls within the unique boundary.

15. The medium of claim 14, wherein the request to associate the unique boundary with the particular region of interest includes data identifying a particular answering group of a particular Public Answering Safety Point (PSAP) of a plurality of PSAPs.

16. The medium of claim 14, wherein the unique boundary is an intersection of each geospatial shape that bounds the particular region of interest identified by the GIS.

17. The medium of claim 14, wherein the unique boundary is a union of each geospatial shape that bounds the particular region of interest identified by the GIS.

18. A method comprising:
receiving cell sector data for cell sectors, wherein the cell sector data characterizes a radius of communication of each cell sector, a beam width of each cell sector, geocoordinates of cell towers for the cell sectors, wherein a first set of the cell sectors communicate on a first carrier network and a second set of the cell sectors communicate on a second carrier network, different from the first carrier network;
generating a geospatial shape for the cell sectors, wherein the geospatial shape for each respective cell sector characterizes geographical boundaries of coverage for a particular protocol on a particular communication network;
receiving a request indicating a particular region of interest;
querying a geographic information system (GIS) for geographic coordinates for a particular region of interest within boundaries of each respective geospatial shape;
determining a unique boundary that is a combination of geospatial shapes that encompass the particular region of interest identified by the GIS;
receiving a request to associate the unique boundary with the particular region of interest and indicating a particular Public Answering Safety Point (PSAP); and
providing, in response to the request, a GIS reference characterizing the unique boundary and PSAP to a network node of a public safety network that determines destination routing for emergency calls.

19. The medium of claim 18, wherein the unique boundary is an intersection of geospatial shapes that bound the particular region of interest identified by the GIS.

20. The medium of claim 14, wherein the unique boundary is a union of geospatial shapes that bound the particular region of interest identified by the GIS.
